(19) United States
(12) Patent Application Publication
(10) Pub. No.: US 2016/0103987 A1
(43) Pub. Date: Apr. 14, 2016

(54) ELECTRONIC DEVICE AND AN UNLOCKING PASSWORD SETTING METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: MIN YANG, Wuhan (CN); XIN-SHU WANG, Wuhan (CN); JIAN-HUNG HUNG, New Taipei (TW)

(21) Appl. No.: 14/695,499

(22) Filed: Apr. 24, 2015

(30) Foreign Application Priority Data
Oct. 14, 2014 (CN) 201410543157.9

(51) Int. Cl. G06F 21/36; G06F 21/60; G06F 21/45

(52) U.S. Cl. CPC G06F 21/36; G06F 21/45; G06F 21/602

(57) ABSTRACT

In an unlocking password setting method executed by a first electronic device, the first electronic device is connected to a second electronic device. Handwriting of a user is captured from an input device when a command of setting the unlocking password of the second electronic device is received. The handwriting is translated into a digital password. The digital password is stored in the first electronic device and the second electronic device as the unlocking password of the second electronic device.

### CROSS-REFERENCE TO RELATED APPLICATIONS

This application claims priority to Chinese Patent Application No. 201410543157.9 filed on Oct. 14, 2014, the contents of which are incorporated by reference herein.

### FIELD

The subject matter herein generally relates to electronic device security technology, and particularly to an electronic device and a method of setting an unlocking password of the electronic device.

### BACKGROUND

Most electronic device unlocking methods are password based. If the password is too short, the electronic device will not be safe. If the password is too long, it is hard for users to remember.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one example embodiment of an electronic device.

FIG. 2 is a block diagram illustrating function modules of an unlocking password setting system.

FIG. 3 is a flowchart of one example embodiment of an unlocking password setting method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The present disclosure, including the accompanying drawings, is illustrated by way of examples and not by way of limitation. It should be noted that references to “an” or “one” embodiment in this disclosure are not necessarily to the same embodiment, and such references mean “at least one”.

The term “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

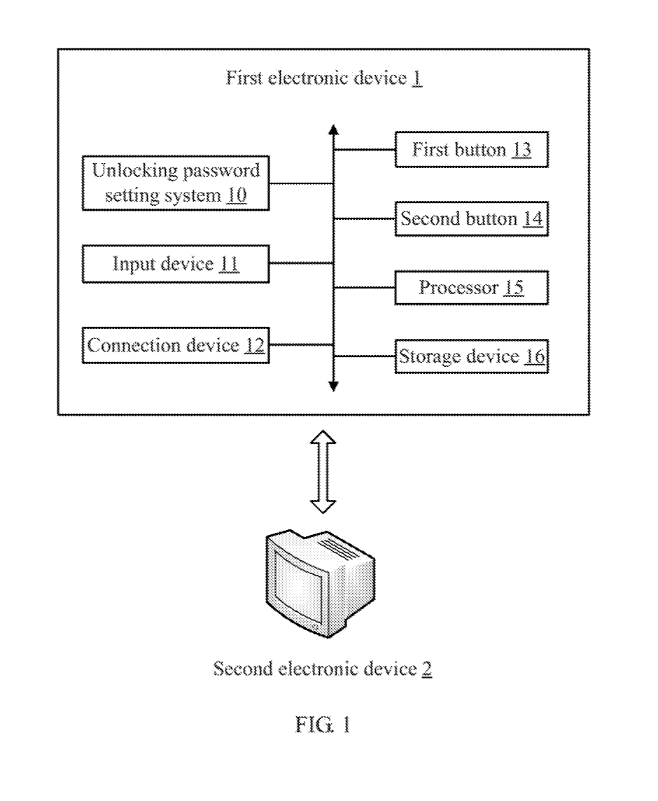

FIG. 1 is a block diagram of one example embodiment of an electronic device. In at least one embodiment as shown in FIG. 1, the electronic device 1 includes a connection device 12 for connecting with another electronic device. For distinguishing purposes, the electronic device 1 is referred to as “the first electronic device 1”, and another electronic device is referred to as “the second electronic device 2.” The first electronic device 1 can connect to the second electronic device 2 through the connection device. The connection device 12 can be a communication interface or a wireless device. The first electronic device 1 can be a mobile phone or any other suitable electronic device. The second electronic device 2 can be a computer, a notebook computer or any other suitable electronic device.

The first electronic device 1 can further include, but is not limited to, an unlocking password setting system 10, an input device 11, a first button 13, a second button 14, at least one processor 15 and a storage device 16. FIG. 1 illustrates only one example of the first electronic device 1. One skilled in the art may know that the first electronic device 1 can include more or fewer components than illustrated, or have a different configuration of the various components in other embodiments.

The input device 11 can be used to receive handwriting of a user. In some embodiments, the input device 11 is configured in the first electronic device 1. The input device 11 can be a touch screen, for example, a touch panel, which supports multi-touch. The touch screen can be such as a resistive touch screen or a capacitive touch screen. In other embodiments, the input device 11 is connected to the first electronic device 1. The input device 11 can be a graphics tablet or any other suitable electronic device. The first button 13, when pressed, can generate a first command of setting an unlocking password of the second electronic device 2, and send the first command to the first electronic device 1. The second button 14, when pressed, can generate a second command of unlocking the second electronic device 2, and send the second command to the first electronic device 1. The first button 13 and the second button 14 can be physical buttons or virtual buttons.

In at least one embodiment, the at least one processor 15 can be a central processing unit (CPU), a microprocessor, or other data processor chip that performs functions of the first electronic device 1. The storage device 16 can include various type(s) of non-transitory computer-readable storage medium. For example, the storage device 16 can be an internal storage system, such as a flash memory, a random access memory (RAM) for temporary storage of information, and/or a read-only memory (ROM) for permanent storage of information. The storage device 16 can also be an external storage system, such as a hard disk, a storage card, or a data storage medium.

The unlocking password setting system 10 can provide functions including setting the unlocking password of the second electronic device 2.

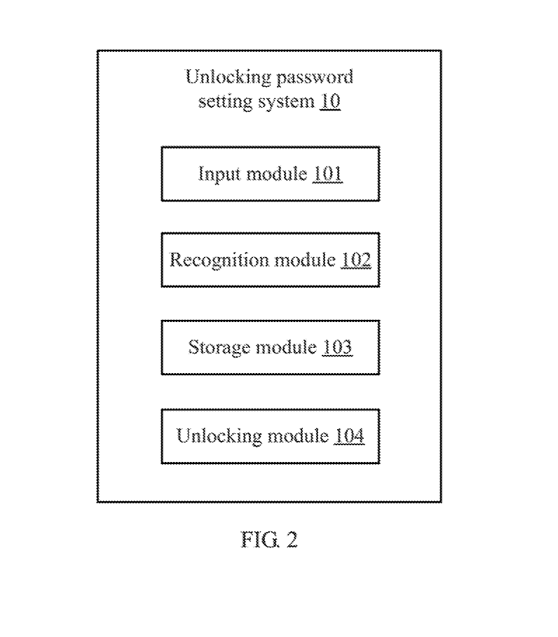

FIG. 2 is a block diagram illustrating function modules of the unlocking password setting system. In at least one embodiment, the unlocking password setting system 10 can include an input module 101, a recognition module 102, a storage module 103 and an unlocking module 104. The function modules 101-104 can include computerized codes in the form of one or more programs, which are stored in the storage device 16. The at least one processor 15 executes the computerized codes to provide functions described below.

When the first electronic device 1 connects to the second electronic device 2 and the first button 13 is pressed, a command of setting the unlocking password of the second electronic device 2 can be received. In response to the command of setting the unlocking password, the input module 101 captures handwriting of a user from the input device 11.

The recognition module 102 translates the handwriting into a digital password using handwriting recognition technology.

Handwriting recognition is the ability to receive and interpret intelligible handwriting input from sources such as paper documents, photographs, touch-screens and other devices. In this embodiment, the handwriting is input from a touch-screen. In one embodiment, the recognition module 102 translates the handwriting into a digital password by the following steps. The first step is preprocessing the handwriting. The purpose of preprocessing is to discard irrelevant information in the handwriting. Preprocessing usually consists of binarization, normalization, sampling and denoising. The second step is feature extraction. Out of the two or more dimensional vector fields received from the preprocessing, higher-dimensional data is extracted. Higher-dimensional data may include information like pressure of writing, velocity or the changes of writing direction. The last step is translating the data into a digital password.

The storage module 103 stores the digital password in the first electronic device 1 and the second electronic device 2 as the unlocking password of the second electronic device 2. The storage module 103 can control the second electronic device 2 to store the digital password as the unlocking password of the second electronic device 2.

In some embodiments, the second electronic device 2 locks after the digital password is stored in the second electronic device 2. In other embodiments, the second electronic device 2 locks when the second electronic device 2 remains in a standby state for a predetermined time period.

In some embodiments, the digital password stored in the first electronic device 1 and the second electronic device 2 are not encrypted. In other embodiments, the digital password stored in the first electronic device 1 and the second electronic device 2 can be encrypted using a same encryption module or two different encryption modules. For example, the digital password stored in the first electronic device 1 is encrypted using a first encryption module. The digital password stored in the second electronic device 2 can be encrypted using the first encryption module or a second encryption module.

When the first electronic device 1 connects to the second electronic device 2 and the second button 14 is pressed, a command of unlocking the second electronic device 2 is received. In response to the command of unlocking the second electronic device 2, the unlocking module 104 sends the digital password stored in the first electronic device 1 to the second electronic device 2.

When receiving the digital password from the first electronic device 1, the second electronic device 2 determines whether the received digital password is the same as the digital password stored in the second electronic device 2. If the received digital password is the same as the digital password stored in the second electronic device 2, the second electronic device 2 unlocks. If the received digital password is not the same as the digital password stored in the second electronic device 2, the second electronic device 2 fails to be unlock.

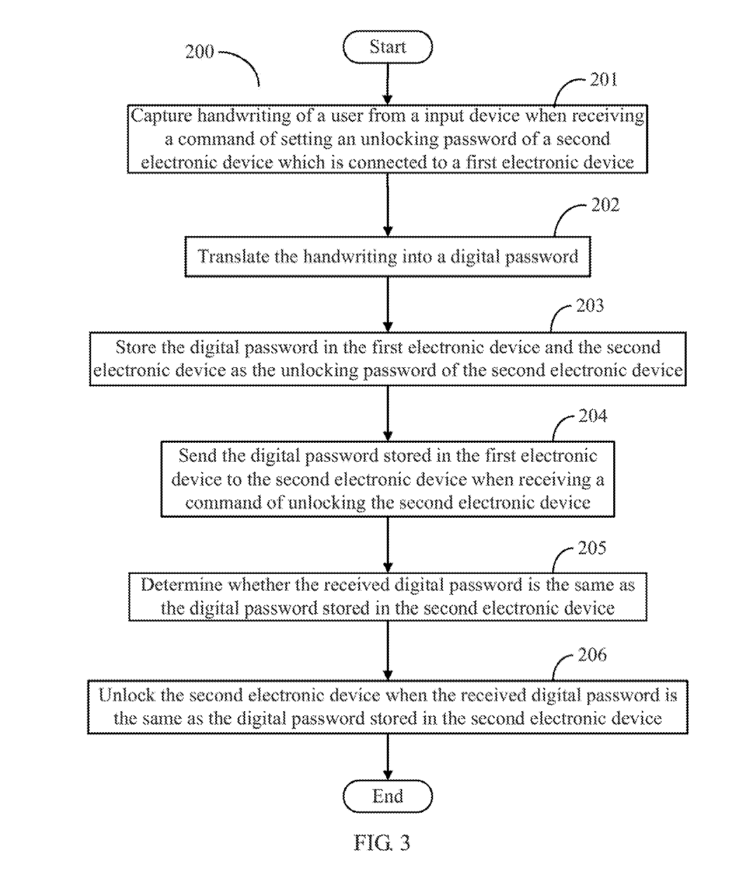

Referring to FIG. 3, a flowchart is presented in accordance with an example embodiment. The example method 200 is provided by way of example, as there are a variety of ways to carry out the method. The example method 200 described below can be carried out using the configurations illustrated in FIG. 1, for example, and various elements of these figures are referenced in explaining example method 200. Each block shown in FIG. 2 represents one or more processes, methods, or subroutines, carried out in the example method 200. Furthermore, the illustrated order of blocks is illustrative only and the order of the blocks can be changed. Additional blocks can be added or fewer blocks may be utilized without departing from this disclosure. The example method 200 can begin at block 201.

When the first electronic device 1 connects to the second electronic device 2 and the first button 13 is pressed, a command of setting the unlocking password of the second electronic device 2 can be received. At block 201, a input module captures handwriting of a user from the input device 11.

At block 202, a recognition module translates the handwriting into a digital password using handwriting recognition technology.

At block 203, a storage module stores the digital password in the first electronic device 1 and the second electronic device 2 as the unlocking password of the second electronic device 2. The storage module can control the second electronic device 2 to store the digital password as the unlocking password of the second electronic device 2. In some embodiments, the second electronic device 2 locks after the digital password is stored in the second electronic device 2. In other embodiments, the second electronic device 2 locks when the second electronic device 2 remains in a standby state for a predetermined time period.

In some embodiments, the digital password stored in the first electronic device 1 and the second electronic device 2 are not encrypted. In other embodiments, the digital password stored in the first electronic device 1 and the second electronic device 2 can be encrypted using a same encryption module or two different encryption modules. For example, the digital password stored in the first electronic device 1 is encrypted using a first encryption module. The digital password stored in the second electronic 2 device can be encrypted using the first encryption module or a second encryption module.

When the first electronic device 1 connects to the second electronic device 2 and the second button 14 is pressed, a command of unlocking the second electronic device 2 is received. At block 204, a unlocking module sends the digital password stored in the first electronic device 1 to the second electronic device 2.

When receiving the digital password from the first electronic device 1, at block 205, the second electronic device 2 determines whether the received digital password is the same as the digital password stored in the second electronic device 2. If the received digital password is the same as the digital password stored in the second electronic device 2, at block 206, the second electronic device 2 unlocks. If the received digital password is not the same as the digital password stored in the second electronic device 2, the second electronic device 2 fails to be unlocked.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. An unlocking password setting method, being executed by at least one processor of a first electronic device, the method comprising:
connecting the first electronic device to a second electronic device;
capturing handwriting of a user from an input device when receiving a command of setting an unlocking password of the second electronic device, the input device being configured in the first electronic device or connected to the first electronic device;
translating the handwriting into a digital password; and
storing the digital password in the first electronic device and the second electronic device as the unlocking password of the second electronic device.

2. The method according to claim 1, further comprising:
sending the digital password stored in the first electronic device to the second electronic device to unlock the second electronic device when the second electronic device is connected to the first electronic device and receives a command of unlocking the second electronic device.

3. The method according to claim 1, wherein the captured handwriting is translated into the digital password using a handwriting recognition technology.

4. The method according to claim 1, wherein the first electronic device is connected to the second electronic device by a communication interface or a wireless device.

5. The method according to claim 1, wherein the digital password stored in the first electronic device and the digital password stored in the second electronic device are encrypted using a same encryption module.

6. The method according to claim 1, wherein the digital password stored in the first electronic device and the digital password stored in the second electronic device are encrypted respectively using two different encryption modules.

7. A first electronic device comprising:
at least one processor; and
a storage device that stores one or more programs which, when executed by the at least one processor, causes the at least one processor to:
capture handwriting of a user from an input device when receiving a command of setting an unlocking password of a second electronic device that is connected to the first electronic device, the input device being configured in the first electronic device or connected to the first electronic device;
translate the handwriting into a digital password; and
store the digital password in the first electronic device and the second electronic device as the unlocking password of the second electronic device.

8. The first electronic device according to claim 7, the at least one processor further:
sends the digital password stored in the first electronic device to the second electronic device to unlock the second electronic device when the second electronic device is connected to the first electronic device and receives a command of unlocking the second electronic device.

9. The first electronic device according to claim 7, wherein the captured handwriting is translated into the digital password using a handwriting recognition technology.

10. The first electronic device according to claim 7, wherein the first electronic device is connected to the second electronic device by a communication interface or a wireless device.

11. The first electronic device according to claim 7, wherein the digital password stored in the first electronic device and the digital password stored in the second electronic device are encrypted using a same encryption module.

12. The first electronic device according to claim 7, wherein the digital password stored in the first electronic device and the digital password stored in the second electronic device are encrypted using two different encryption modules.

13. A non-transitory storage medium having shored thereon instruction that, when executed by at least one processor of a first electronic device, causes the at least one processor to perform an unlocking password setting method, the method comprising:
connecting the first electronic device to a second electronic device;
capturing handwriting of a user from an input device when receiving a command of setting an unlocking password of the second electronic device, the input device being configured in the first electronic device or connected to the first electronic device;
translating the handwriting into a digital password; and
storing the digital password in the first electronic device and the second electronic device as the unlocking password of the second electronic device.

14. The non-transitory storage medium according to claim 13, wherein the method further comprising:
sending the digital password stored in the first electronic device to the second electronic device to unlock the second electronic device when the second electronic device is connected to the first electronic device and receives a command of unlocking the second electronic device.

15. The non-transitory storage medium according to claim 13, wherein the captured handwriting is translated into the digital password using a handwriting recognition technology.

16. The non-transitory storage medium according to claim 13, wherein the first electronic device is connected to the second electronic device by a communication interface or a wireless device.

17. The non-transitory storage medium according to claim 13, wherein the digital password stored in the first electronic device and the digital password stored in the second electronic device are encrypted using a same encryption module.

18. The non-transitory storage medium according to claim 13, wherein the digital password stored in the first electronic device and the digital password stored in the second electronic device are encrypted using two different encryption modules.
